(19) United States
(12) Patent Application Publication
(10) Pub. No.: US 2007/0176030 A1
(43) Pub. Date: Aug. 2, 2007

(54) Tension control device for mobile irrigation systems

(76) Inventor: Thomas J. Korus, Lindsay, NE (US)

Correspondence Address: HOVEY WILLIAMS LLP, 2405 GRAND BLVD., SUITE 400, KANSAS CITY, MO, 64108, US

(21) Appl. No.: 11/335,084

(22) Filed: Jan. 19, 2006

(51) Int. Cl. B05B 3/00

(52) U.S. Cl. 239/729

(57) ABSTRACT

The left and right truss rod assemblies of a truss that supports the span of an irrigation pipeline are bridged by a single sensor device. A movable linear connector in the sensor receives oppositely directed loads from axially spaced members of the two truss rod assemblies and provides a linear motion that can be transmitted to a control device to shut down the system if tension force in the truss becomes excessive. Movement of the linear connector is yieldably resisted by a resilient element, which resistance is overcome if and when the tension force in the truss exceeds a threshold level.

### TECHNICAL FIELD

The present invention relates generally to agricultural irrigation machines and, more particularly, to a safety device for detecting untoward tension in an overhead pipeline span such as when one or more of the self-propelled towers supporting the span encounters an obstruction in the field. Such detection can be utilized to shut down the entire system, provide a warning signal, or initiate other appropriate action.

### BACKGROUND AND SUMMARY

The overhead pipelines of conventional agricultural irrigation systems are typically provided with a number of end-to-end spans or sections, each of which is supported by a self-propelled tower having ground-engaging wheels. Between each pair of towers, the pipeline span is typically maintained in a slightly upwardly arched or bowed configuration by a truss beneath the pipeline. Such truss typically includes a pair of left and right truss rods extending generally parallel to the pipeline on opposite lateral sides thereof, as well as an assemblage of other members interconnecting the truss rods and the pipeline.

The present invention relates to a safety device that is incorporated into the truss of such a pipeline to detect excessive tension in the truss such as might occur in the event the machine encounters a serious obstruction during movement through the field. Such detection can then be used to actuate switching mechanism or the like to completely shut down the system or otherwise take corrective action.

More particularly, the present invention contemplates an arrangement wherein both left and right truss rod assemblies of a truss are serviced by a single sensor that bridges the two assemblies and thus responds to untoward tension in the truss. In a preferred form of the invention, the sensor device includes a first component that bridges one pair of left and right truss rod members that are spaced axially from a second pair of left and right truss members. Another component bridges the second pair of truss rod members and is yieldably interconnected with the first component such that the two components can move relative to one another in an axial direction when a tension force exceeding a predetermined amount is applied to the truss. Preferably, the yieldable interconnection between the two components is established in part by a compressible element constructed of a suitable polyurethane material or the like. A draw bolt or other connector passes through a central bore of the compressible element and is anchored at one end to the first pair of truss rod members while having a suitable linkage such as a cable connected to the opposite end thereof for operating an electrical switch or the like associated with control circuitry for the motors that drive the ground wheels of the machine.

### BRIEF DESCRIPTION OF THE DRAWINGS

FIG. 1 is a fragmentary isometric view of an agricultural irrigation machine constructed in accordance with the principles of the present invention;

FIG. 2 is an enlarged, fragmentary elevational view of a sensor device in accordance with the present invention incorporated into the truss beneath a span of the overhead pipeline of the machine;

FIG. 3 is a fragmentary, bottom elevational view of the sensor device and associated truss members taken substantially along sight line 3-3 of FIG. 2;

FIG. 4 is a fragmentary isometric view of the sensor device from the bottom of the pipeline span; and

FIG. 5 is an exploded isometric view of various parts of the sensor device and truss.

### DETAILED DESCRIPTION

The present invention is susceptible of embodiment in many different forms. While the drawings illustrate and the specification describes certain preferred embodiments of the invention, it is to be understood that such disclosure is by way of example only. There is no intent to limit the principles of the present invention to the particular disclosed embodiments.

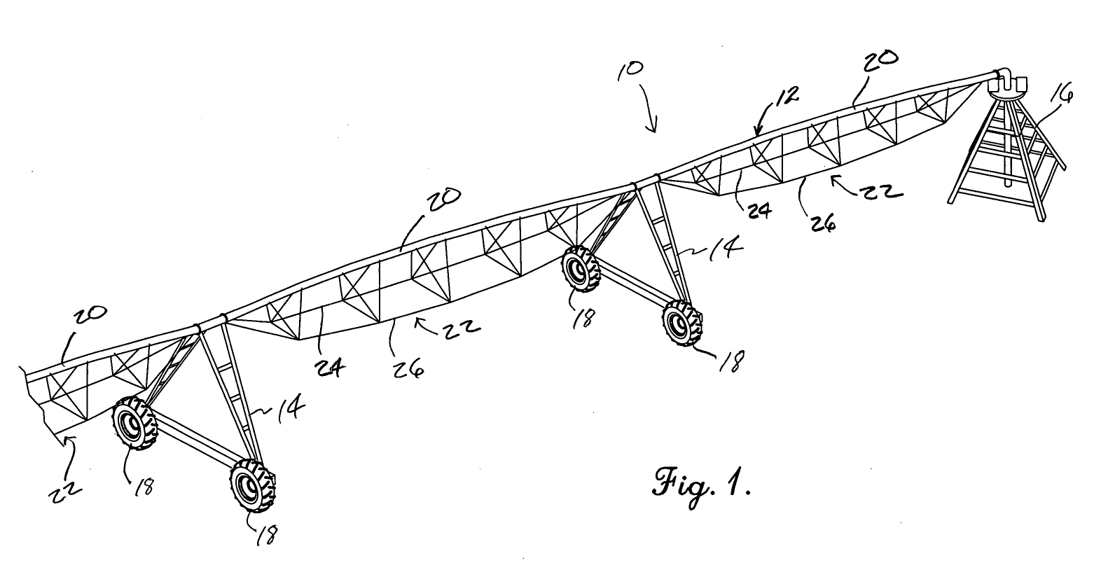

FIG. 1 illustrates an agricultural irrigation machine 10 of the “center pivot” style in which an overhead pipeline 12 is supported by a number of self-propelled towers 14 that swing the pipeline 12 about a central, stationary tower 16. Pipeline 12 is coupled with a source of water under pressure so as to deliver the water to a plurality of sprinklers or the like (not shown) along the length of pipeline 12. Ground wheels 18 associated with each tower 14 are driven by suitable motive means such as electric motors (not shown) but well known to those skilled in the art. U.S. Pat. No. 4,618,102 owned by the assignee of the present invention is hereby incorporated by reference into the present specification as an example of one such motor and gearbox arrangement.

Although a center pivot irrigation machine has been illustrated in FIG. 1, it is to be understood that the principles of the present invention are not limited to that particular style of machine. Although for exemplary purposes the invention will hereinafter be described in connection with one of the trusses of rigidly interconnected spans of the pipeline 12 illustrated in FIG. 1, the present invention has utility in connection with any span of an irrigation machine utilizing a supporting truss. For example, a control device of the herein described type is particularly useful on a link span of a combination lateral move and center pivot unit wherein the link span has no mobile tower that directly supports the span; instead, it connects the outer end of the center pivot unit with the inner end of a lateral move unit so as to supply water to the corner or other hard-to-reach portion of a field. One such combination machine is disclosed in U.S. Pat. No. 4,674,681 owned by the assignee of the present invention and hereby incorporated by reference into the present specification.

The pipeline 12 in FIG. 1 comprises a series of pipeline spans 20 connected in end-to-end relationship. Each pipeline span 20 is provided with its own truss 22 that supports the span and maintains it in a slightly upwardly arched or bowed configuration. Among other structure, each truss 22 includes a pair of left and right truss rod assemblies 24 and 26 that extend generally parallel to pipeline span 20 below the latter and on opposite left and right sides thereof. Each of such truss rod assemblies 24, 26 typically utilizes rods of round cross-section or flat straps; however, wire cable or hollow tube and other members capable of being put in tension could also be used.

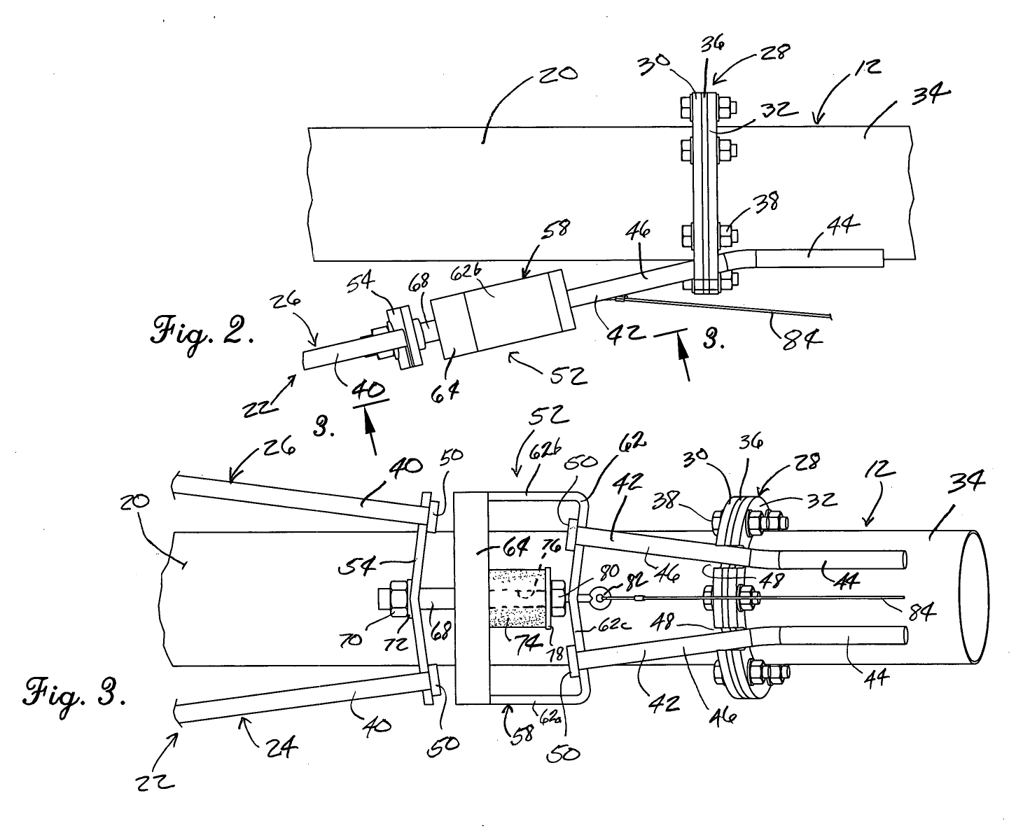

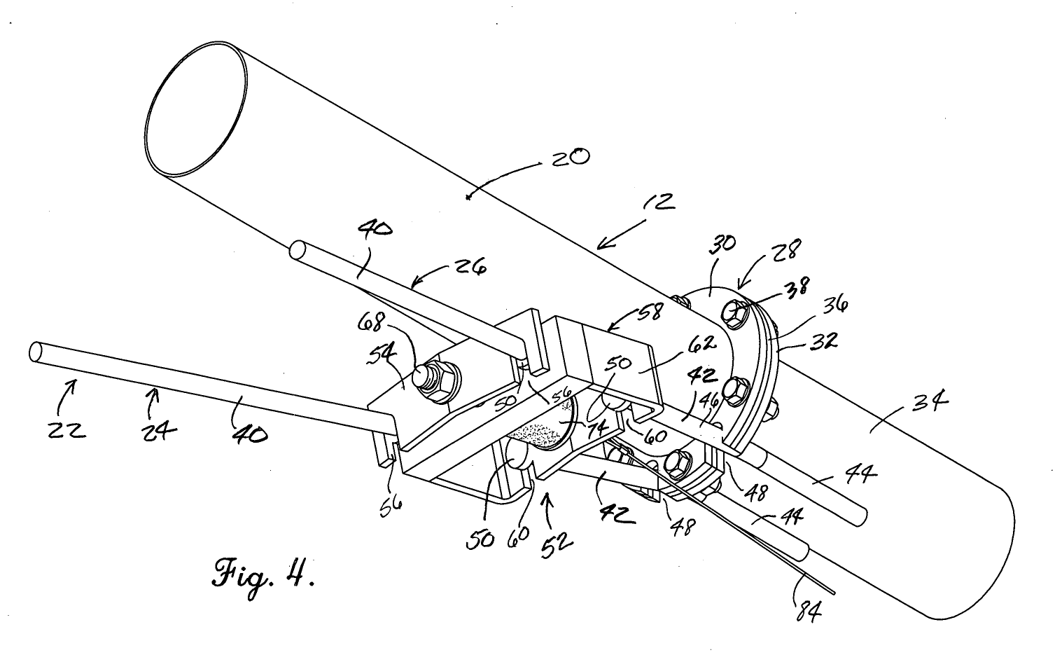

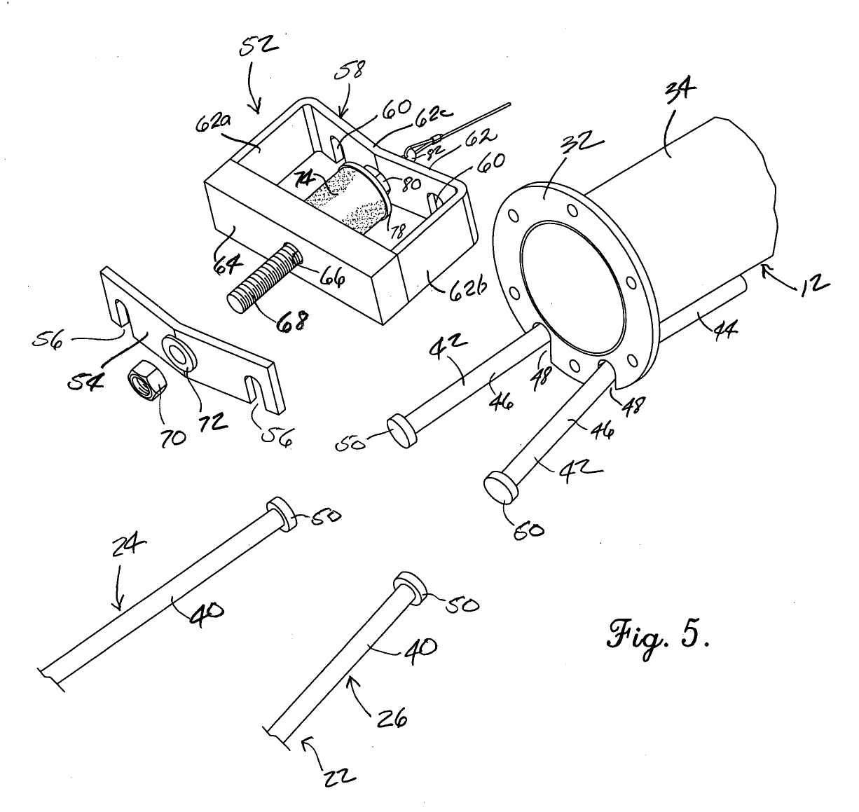

FIGS. 2-5 afford more close-up views of the truss rod assemblies 24, 26, particularly at a rigid joint between the short section 34 of pipeline at a mobile tower 14 and the next span 20. Such a joint is denoted by the numeral 28 and includes a pair of flanges 30 and 32 on span 20 and short section 34 respectively. A suitable gasket 36 is sandwiched between flanges 30, 32 and compressed tightly by a series of circumferentially spaced bolts 38 between flanges 30, 32.

Each tension rod assembly 24, 26 includes a pair of truss members 40, 42 that are axially spaced apart. In the illustrated embodiment, the left and right truss members 40 of assemblies 24, 26 are connected at their remote ends to other portions of the truss 22, while left and right truss members 42 serve as anchors for securing the proximal end of truss 22 with pipeline 12. In the illustrated embodiment, each of the anchoring truss members 42 includes an anchoring portion 44 that is fixed as by welding to the underside of pipe section 34, and a connecting portion 46 that extends downwardly at an angle from the outer end of anchoring portion 44. Clearance notches 48 are provided in the flanges 30, 32 and gasket 36 to provide clearance for connecting portions 46. As noted particularly in FIG. 3, connecting portions 46 of anchoring truss members 42 diverge as their outer and downward ends are approached, such divergence being at the same rate as the divergence of truss members 40 as also illustrated particularly well in FIG. 3. Each of the truss members 40, 42 has an enlargement 50 at its outer end.

In accordance with the present invention, the truss 22 is provided with a tension sensor device 52 incorporated into and forming a part of truss 22. Sensor 52 comprises a single sensor that is connected across both left and right truss rod assemblies 24, 26 for producing a linear displacement under significant load changes in truss 22.

In the illustrated embodiment, sensor 52 includes a first transverse component 54 generally in the nature of a rigid strap that interconnects the left and right truss members 40 just inboard of their enlargements 50. Transverse component 54 may be attached to left and right members 40 by any suitable means such as, for example, by having notches 56 in the lower extremity of component 54 that are sized to receive the members 40 but prevent enlargements 50 from pulling therethrough.

A second transverse component 58 of sensor 52 spans the anchoring truss members 42 just inboard of their enlargements 50 and is connected thereto by any one of a number of suitable means. In the illustrated embodiment, a pair of downwardly opening notches 60 in second component 58 are sized to receive anchoring truss members 42 but preclude passage therethrough of enlargements 50 so as to provide a means of connection of second component 58 with anchoring truss members 42.

In the illustrated embodiment, second component 58 includes a generally U-shaped piece 62 having a pair of legs 62a and 62b, as well as a bight 62c interconnecting legs 62a and 62b. Notches 60 are in bight 62c. The ends of legs 62a, 62b remote from bight 62c are rigidly affixed to a cross bar 64 having a hole 66 (FIG. 5) therethrough.

First and second components 54, 58 of sensor 52 are yieldably and resiliently interconnected so as to permit relative movement therebetween. To this end, a connector in the form of a bolt 68 passes reciprocably through hole 66 in cross bar 64 and is joined at one end to first component 54 by a nut 70 and washer 72. At its other end, connector 68 is connected to second component 58 by virtue of a compressible, resilient element 74 constructed of polyurethane material or the like. Compressible element 74 has a bore 76 therethrough (FIG. 3) that receives connector 68. One end of element 74 bears against the proximal side of cross bar 64, while the opposite end of element 74 bears against a washer 78 beneath the head 80 of connector 68. Movement of truss members 40 axially away from truss members 42 is thus resisted by compressible element 74 but is permitted when a predetermined tension force level tending to separate components 54 and 58 is exceeded.

It will be appreciated that when truss members 40 separate axially from truss members 42 as a result of untoward tension in truss 22, connector bolt 68 extends a corresponding amount from cross bar 64 of second component 58. Such linear movement can be used to trigger an electronic device (not shown) that controls operation of the motors associated with ground wheels 18. The resulting actuation of the electronic device can be used as a signal to completely shut down the motors which drive wheels 18 or to simply provide an appropriate alerting signal to some remote user that corrective action is needed. Electronic devices used to control irrigation machines are well known by those skilled in the art. One example of such a control is disclosed in U.S. Pat. No. 6,042,031 which is incorporated herein by reference.

In order to transmit the linear movement of connector 68 to the electronic control device, a number of means may be utilized. In the illustrated embodiment, the head 80 of connector 68 is provided with a rigid eyebolt 82 that passes through a hole (not shown) in bight 62c and is connected at its distal end with a cable 84 or other link leading to the electronic device for mechanically actuating the same.

Of course, although an electronic control device is the most preferred, in practice other types of control devices could be utilized. For example, various types of mechanical, hydraulic, pneumatic or water-powered devices may be acceptable.

It will be appreciated that while sensor device 52 has been hereinabove described primarily in connection with sensing untoward tension in truss 22, it could also be used to provide a linear signal in the event of untoward compression of the pipeline span 22. Thus, instead of actuating the electronic device in response to a pulling on cable 84 due to increased extension of connector 68 from cross bar 64, compressible element 74 could be subjected to a predetermined preload so as to produce a certain amount of extension of connector 68 from cross bar 64. Then, in the event of untoward compression in pipeline span 20, the axial space between truss members 40 and 42 would decrease, permitting connector 68 to be retracted within sensor 52 as compressible element 74 moves toward an uncompressed state. Such motion would be transmitted to the electronic device via the cable 84 or other link.

The inventor(s) hereby state(s) his/their intent to rely on the Doctrine of Equivalents to determine and assess the reasonably fair scope of his/their invention as pertains to any apparatus not materially departing from but outside the literal scope of the invention as set out in the following claims.

1. In a mobile irrigation system, the improvement comprising:
a pipeline;
a truss supporting the pipeline,
said truss including a first pair of left and right, laterally spaced apart truss members and a second pair of left and right, laterally spaced apart truss members spaced axially from said first pair of truss members; and
a tension sensor interconnecting said first and second pairs of truss members for detecting tension changes in the truss.

2. In a mobile irrigation system as claimed in claim 1,
said sensor including a first component interconnecting said first pair of truss members and a second component interconnecting said second pair of truss members,
said first and second components being yieldably interconnected and relatively movable away from one another in an axial direction when a tension force applied thereto exceeds a predetermined level.

3. In a mobile irrigation system as claimed in claim 2,
further comprising a rigid connector extending between said first and second components and movable with said first component and relative to said second component when a tension force applied to the first and second components exceeds said predetermined level,
further comprising a compressible element coupled with said connector and said second component in a manner to yieldably resist said movement of the connector.

4. In a mobile irrigation system as claimed in claim 3,
said compressible element having a bore there through,
said connector passing through said bore.

5. In a mobile irrigation system as claimed in claim 4,
said compressible element having a pair of opposite ends,
one end of said compressible element bearing against said second component,
said connector having an enlargement bearing against the other end of said compressible element.
